(19) United States
(12) Patent Application Publication
(10) Pub. No.: US 2002/0162280 A1
(43) Pub. Date: Nov. 7, 2002

(54) Profiled belt-type regulator

(76) Inventor: Athar Shah, Troy, MI (US)

Correspondence Address: William S. Gottschalk, CARLSON, GASKEY & OLDS, P.C., 400 West Maple Road, Suite 350, Birmingham, MI, 48009, US

(21) Appl. No.: 09/846,044

(22) Filed: May 1, 2001

(51) Int. Cl. E05F 11/38

(52) U.S. Cl. 49/352; 49/349; 49/348

(57) ABSTRACT

A regulator assembly is provided that may be used as part of a door module. Attachment of the regulator components to the panel provides a convenient door module for attachment to a door. The regulator assembly may also be used for sunroofs. The assembly includes a glass support member for supporting a pane of glass or window. A drive motor produces a drive force for moving the glass support between open and closed positions. A flexible belt, such as a timing belt, includes a profile. The belt interconnects the drive motor and the glass support member. In a preferred embodiment, spaced apart brackets may be connected to a panel for supporting opposing end portions of the belt. A drive pulley has a complimentary profile to the profile of the belt. The drive pulley is connected to the drive motor with the drive pulley engaging the belt and movable relative thereto in response to the drive force. The regulator may incorporate a continuous loop belt or a belt having terminal ends that are affixed to a mounting member.

### BACKGROUND OF THE INVENTION

This invention relates to a regulator assembly for driving a glass pane between open and closed positions in a vehicle, and more particularly, the invention relates to a window regulator assembly utilizing a belt.

Regulator assemblies are used to drive vehicle windows and sunroofs between open and closed positions. The assemblies typically include a drive mechanism to move the window and guides to define the path of movement. Numerous types of regulator assemblies have been used. For example, an arm and sector regulator typically used for windows incorporates a scissor-like device for opening and closing the window. Arm and sector regulator drive mechanisms typically incorporate a metal lever that is driven by a drive motor along a central guide, in addition to lateral guides. Arm and sector regulators utilize numerous specialized stampings unique to a particular window. Furthermore, the components are rather heavy.

Another type of regulator is commonly referred to as a drum and cable regulator. Drum and cable regulators incorporate a drive mechanism having one or more drums that carry a steel cable. The window is supported on the cable by a bracket. The window is moved between the opened and closed positions as the cable is driven about the drums. Over the life of the regulator, the cable tends to stretch thereby compromising the operation of the window regulator. Moreover, the drum and cable regulators typically require a control guide for the bracket, in addition to lateral guides. Similar to arm and sector regulators, the drum and cable regulator is typically rather heavy.

Therefore, what is needed is a lighter weight regulator which provides an acceptable performance that does not degrade over time.

### SUMMARY OF THE INVENTION AND ADVANTAGES

The present invention provides a regulator assembly that may be used as part of a door module. Attachment of the regulator components to the panel provides a convenient door module for attachment to a door. The regulator assembly may also be used for sunroofs. The assembly includes a glass support member for supporting a pane of glass or window. A drive motor produces a drive force for moving the glass support member between open and closed positions. A flexible belt, such as a timing belt, includes a profile. The belt interconnects the drive motor and the glass support member. In a preferred embodiment, spaced apart brackets may be connected to a panel for supporting opposing end portions of the belt. A drive pulley has a complimentary profile to the profile of the belt. The drive pulley is connected to the drive motor with the drive pulley engaging the belt and movable relative thereto in response to the drive force. The regulator may incorporate a continuous loop belt or a belt having terminal ends that are affixed to a mounting member.

Accordingly, the above invention provides a lighter weight regulator which provides an acceptable performance that does not degrade over time.

### BRIEF DESCRIPTION OF THE DRAWINGS

Other advantages of the present invention can be understood by reference to the following detailed description when considered in connection with the accompanying drawings wherein:

FIG. 1 is a schematic view of the belt-type regulator of the present invention;

FIG. 2 is an end view of a portion of the regulator as shown in FIG. 1;

FIG. 3 is a perspective view of the drive pulley and belt of the present invention; and

FIG. 4 is an end view of another embodiment of the regulator of the present invention.

### DETAILED DESCRIPTION OF THE PREFERRED EMBODIMENT

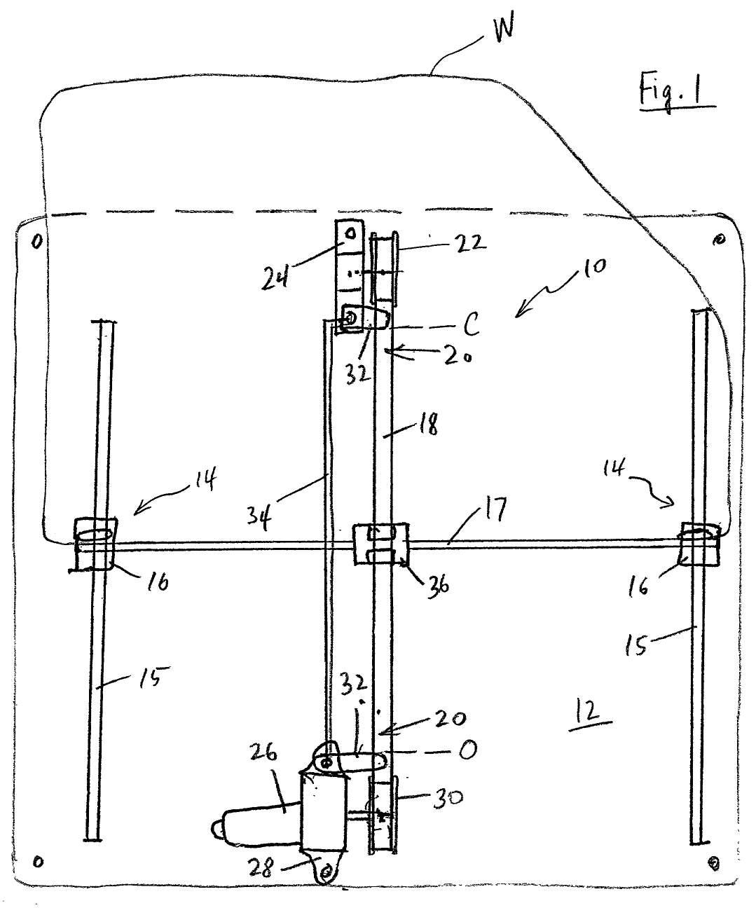

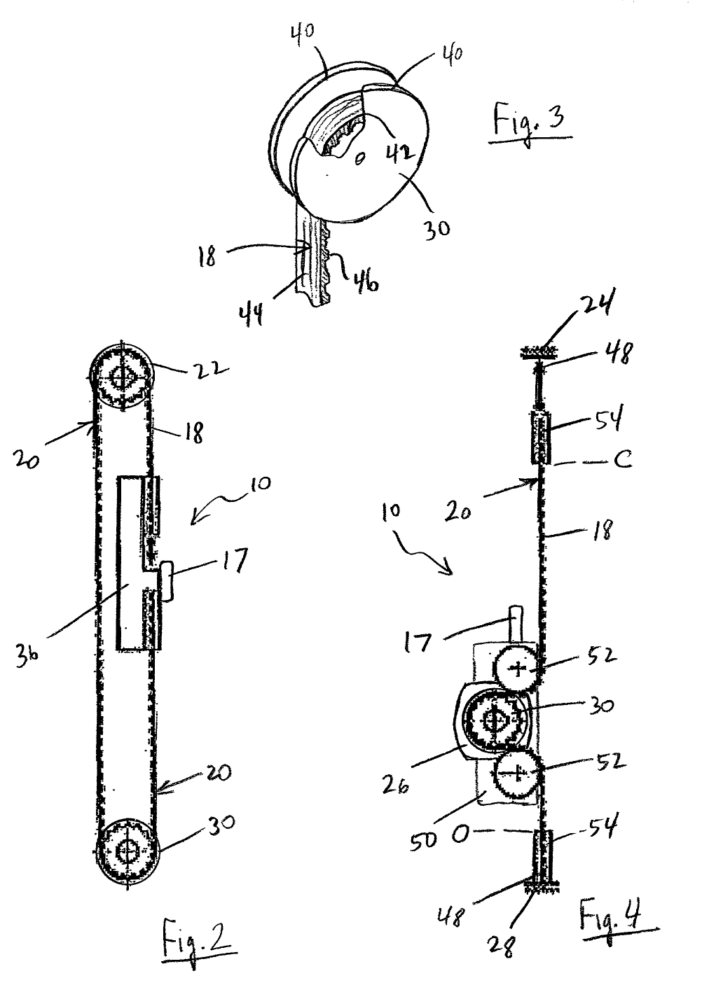

The present invention regulator assembly 10 is shown in FIG. 1. Preferably, the regulator assembly 10 makes up a door module that may be secured to a door as a unit. With a door module embodiment, the regulator assembly 10 may include a panel 12. The regulator assembly 10 may also be used for sunroof applications. Spaced guides 14 support a glass support member 17 to which a window or glass pane W is secured. The guides 14 may include a rail 15 and follower 16 secured to the glass support member 17 for guiding the members 17 along the rails 15. A flexible profile belt 18 is connected to the glass support member 17. The belt 18 includes opposing end portions 20. In one embodiment, shown in FIGS. 1 and 2, the belt 18 is supported at opposing end portions 20 by a support pulley 22 and a drive pulley 30. The support pulley 22 is connected to an upper bracket 24, which is secured to the panel 12. A drive motor 26 is connected to the drive pulley 30 and is supported by lower bracket 28, which is secured to the panel 12. The drive motor 26 provides a drive force for rotatingly driving the drive pulley 30 and moving the belt 18 relative to the drive pulley 30 to move the glass support member 17 between closed C, and opened O positions. The opened O and closed C positions are defined by stops 32, which may be secured to the brackets 24 and 28.

A rod 34 may be connected to the brackets 24 and 28 for maintaining a distance between the pulleys 22 and 30 during installation. The rod 34 ensures that the belt 18 and drive pulley 30 remain in engagement with one another. However, if the panel 12 is used, the rod 34 may not be needed since the brackets 24 and 20 may be secured to the panel 12 prior to installation of the regulator assembly 10 to the door or other appropriate vehicle structure. If a panel 12 is not used, it may be more convenient to utilize the rod 34 between the brackets 24 and 28 to aid in installation of the regulator assembly 10 to the door.

A mounting member 36 is secured to the belt 18 for connecting the glass support member 17 to the belt 18, as best shown in FIG. 2. The mounting member 36 may be secured to the belt 18 in any suitable manner, such as by rivets or clamping. For the configuration shown in FIGS. 1 and 2, the glass support member 17 is fixed relative to the belt 18 so that it moves with the belt 18 as it is driven about the pulleys 22 and 30.

In the most preferred embodiment of the invention, the drive pulley 30 is a timing pulley, and the flexible belt 18 is a timing belt. For this type of belt and pulley arrangement, the belt and pulleys have complimentary profiles that interlock with one another. The drive pulley 30 includes spaced apart flanges 40 that ensure that the belt 18 does not slide from the pulley 30 as they move relative to one another. The drive pulley 30 includes a profile 42 having teeth arranged radially about the pulley. The belt 18 is preferably constructed from a rubberized fabric with embedded steel wires or other reinforcing members to maintain the structural integrity of the belt 18 under a variety of temperature and stress conditions. The regulator assembly 10 of the present invention is especially desirable since a wide range of the belts 18 are presently commercially available. Furthermore, the timing belts 18 are highly durable and resistant to stretching. Moreover, the interlocking profiles 42 and 46 prevent slippage of the belt 18 relative to the pulley 30.

Another embodiment of the regulator assembly 10 is shown in FIG. 4. In this embodiment, the belt 18 includes terminal ends 48 that are fixedly supported to a member such as the panel 12, by brackets 24 and 28. A drive support 50 may support the drive motor 26. The belt 18 may be routed through idler pulleys 52 to ensure that the belt 18 maintains engagement with the drive pulley 30. The glass support member 17 is connected to the drive support 50 for movement between the open O and closed C positions. Stops 54 may be secured to the opposing portions 20 of the belt 18 to define the opened O and closed C positions.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A regulator assembly comprising:
a glass support member for supporting a pane of glass;
a drive motor producing a drive force for moving said glass support member between open and closed positions;
a flexible belt having a profile, said belt interconnecting said drive motor and said glass support member; and
a pulley with a complementary profile to said profile of said flexible belt, said pulley engaging said belt and movable relative thereto in response to said drive force.

2. The assembly as set forth in claim 1, wherein said belt is a timing belt and said pulley is a timing pulley.

3. The assembly as set forth in claim 1, wherein said pulley is a drive pulley connected to said drive motor for receiving said drive force.

4. The assembly as set forth in claim 3, wherein belt is a continuous loop supported between said drive pulley and a support pulley.

5. The assembly as set forth in claim 4, wherein said pulleys are supported by spaced apart brackets.

6. The assembly as set forth in claim 5, wherein said brackets includes stops defining said open and closed positions.

7. The assembly as set forth in claim 1, further including spaced apart guides supporting said glass support member with said belt arranged generally parallel between said guides.

8. The assembly as set forth in claim 3, wherein said belt includes terminal ends fixedly supported by brackets with said pulley arranged between said brackets.

9. The assembly as set forth in claim 8, further including a drive support supporting a said drive motor and at least one idler pulley adjacent to said drive pulley for maintaining engagement between said belt and drive pulley, and said glass support member connected to said drive support.

10. The assembly as set forth in claim 8, wherein said belt includes end portions with stops defining said open and closed positions.

11. The assembly as set forth in claim 1, further including a rod supporting opposing portions of said belt to maintain a distance between said opposing portions during installation of the assembly onto a door.

12. A regulator door module for a door comprising:
a panel adapted to be secured to the door;
a glass support member for supporting a pane of glass;
a drive motor producing a drive force for moving said glass support member between open and closed positions;
a flexible belt having a profile, said belt interconnecting said drive motor and said glass support member;
spaced apart brackets connected to said panel supporting opposing end portions of said belt; and
a drive pulley with a complementary profile to said profile of said flexible belt, said drive pulley connected to said drive motor with said drive pulley engaging said belt and movable relative thereto in response to said drive force.

13. The module as set forth in claim 12, wherein said belt is a timing belt and said pulley is a timing pulley.

14. The module as set forth in claim 12, wherein belt is a continuous loop supported between said drive pulley and a support pulley with said pulleys supported by said brackets.

15. The module as set forth in claim 14, wherein said brackets includes stops defining said open and closed positions.

16. The module as set forth in claim 12, further including spaced apart guides secured to said panel supporting said glass support member with said belt arranged generally parallel between said guides.

17. The module as set forth in claim 12, wherein said belt includes terminal ends fixedly supported by brackets with said pulley arranged between said brackets.

18. The module as set forth in claim 17, further including a drive support supporting a said drive motor and at least one idler pulley adjacent to said drive pulley for maintaining engagement between said belt and drive pulley, and said glass support member connected to said drive support.

19. The module as set forth in claim 17, wherein said end portions include stops defining said open and closed positions.
